(19) United States
(12) Patent Application Publication
(10) Pub. No.: US 2015/0290826 A1
(43) Pub. Date: Oct. 15, 2015

(54) CUTTING APPARATUS AND CUTTING METHOD

(71) Applicant: TOYOTA JIDOSHA KABUSHIKI KAISHA, Toyota-shi, Aichi (JP)

(72) Inventor: Kazumi SAITO, Okazaki-shi, Aichi (JP)

(73) Assignee: TOYOTA JIDOSHA KABUSHIKI KAISHA, Toyota-shi, Aichi (JP)

(21) Appl. No.: 14/647,234

(22) PCT Filed: Nov. 30, 2012
(86) PCT No.: PCT/JP2012/081173

§ 371 Date: May 26, 2015

(51) Int. Cl. B26D 5/08; B23D 27/00

(52) U.S. Cl. CPC B26D 5/08; B23D 27/00

(57) ABSTRACT

Provided is a technique capable of extending a life of a punch provided in a nibbler. A cutting apparatus for cutting a steel plate, including at least one robot which has an arm capable of changing the position and the posture thereof; a nibbler attached to the tip of the arm, which has a punch reciprocating in a top-bottom direction to punch the steel plate; and a control device which controls the robot and the nibbler. The nibbler makes the punch continuously punch the steel plate while being moved by the robot, thereby cutting the steel plate. The control device has a robot controlling part which controls the robot so that the nibbler moves at a moving velocity depending on the shape of a moving path of the nibbler, and a punch controlling part which changes a frequency of the punch according to the moving velocity of the nibbler.

### TECHNICAL FIELD

The present invention relates to a cutting apparatus and cutting method for cutting a steel sheet.

### BACKGROUND ART

Conventionally, a nibbler is widely known as a device for cutting a steel sheet.

Generally, the nibbler includes a cylindrical case, a punch arranged in the case, and a die arranged below the case. The nibbler makes the punch continuously punch a steel sheet fed between the case and the die while moving, thereby cutting the steel sheet.

JP 9-234622 A discloses a hand nibbler configured to be grasped and moved by an operator to cut a steel sheet.

On the other hand, the nibbler may be attached to a robot.

If the nibbler is attached to the robot, the robot is controlled to move the nibbler along a predetermined path.

When the nibbler is curvedly moved, the robot is controlled to make a moving velocity of the nibbler smaller than when the nibbler is linearly moved because of the structure of the robot.

In particular, when the nibbler is curvedly moved, the moving velocity of the nibbler becomes extremely small in the case where the radius of curvature in a moving path of the nibbler is extremely small, and consequently an area of a scrap cut out from the steel sheet in one punching becomes extremely small.

Therefore, the number of punching during a cut of the steel sheet increases.

This results in easy abrasion of the punch of the nibbler, and a short life of the punch.

### CITATION LIST

### Patent Literature

PTL1: JP 9-234622 A

### SUMMARY OF INVENTION

### Technical Problem

The object of the present invention is to provide a technique capable of extending a life of a punch provided in a nibbler.

### Solution to Problem

A first aspect of the invention is a cutting apparatus for cutting a steel sheet, including at least one robot which has an arm capable of changing a position and a posture of the arm; a nibbler attached to a tip of the arm of the robot, which has a punch reciprocating in a top-bottom direction to punch the steel sheet; and a control device which controls the robot and the nibbler. The nibbler makes the punch continuously punch the steel sheet while being moved by the robot, thereby cutting the steel sheet. The control device has a robot controlling part which controls the robot so that the nibbler moves at a moving velocity depending on a shape of a moving path of the nibbler, and a punch controlling part which changes a frequency of the punch according to the moving velocity of the nibbler.

Preferably, the punch controlling part of the control device obtains the moving velocity of the nibbler and the frequency of the punch. If the punch controlling part determines that a ratio of the frequency of the punch to the moving velocity of the nibbler is larger than a predetermined value, the punch controlling part reduces the frequency of the punch so that the ratio of the frequency of the punch to the moving velocity of the nibbler is the predetermined value. If the punch controlling part determines that the ratio of the frequency of the punch to the moving velocity of the nibbler is smaller than the predetermined value, the punch controlling part increases the frequency of the punch so that the ratio of the frequency of the punch to the moving velocity of the nibbler is the predetermined value.

A second aspect of the invention is a cutting method for cutting a steel sheet, including attaching a nibbler to at least one robot, the nibbler having a punch which reciprocates in a top-bottom direction to punch the steel sheet; controlling the robot so that the nibbler moves at a moving velocity depending on a shape of a moving path of the nibbler; and changing a frequency of the punch according to the moving velocity of the nibbler.

Preferably, if a ratio of the frequency of the punch to the moving velocity of the nibbler is larger than a predetermined value, reducing the frequency of the punch so that the ratio of the frequency of the punch to the moving velocity of the nibbler is the predetermined value. If the ratio of the frequency of the punch to the moving velocity of the nibbler is smaller than the predetermined value, increasing the frequency of the punch so that the ratio of the frequency of the punch to the moving velocity of the nibbler is the predetermined value.

### Advantageous Effects of Invention

The present invention makes it possible to extend a life of a punch provided in a nibbler.

### BRIEF DESCRIPTION OF DRAWINGS

FIG. 1 shows a cutting apparatus according to an embodiment of the present invention.

FIG. 2 shows a nibbler provided in the cutting apparatus according to the embodiment of the present invention, in which FIG. 2A is sectional side view, and FIG. 2B is an end view taken along line A-A of FIG. 2A.

FIG. 3 shows a moving path of the nibbler, a moving velocity of the nibbler, and a frequency of a punch of the nibbler during a cut of a steel sheet by the nibbler.

FIG. 4 shows control of the frequency of the punch by a punch controlling part of a control device.

FIG. 5 is a plan view of a scrap punched from the steel sheet by a conventional nibbler, in which FIG. 5A is a plan view of a scrap when a moving velocity of the nibbler is relatively large, and FIG. 5B is a plan view of a scrap when the moving velocity of the nibbler is relatively small.

FIG. 6 shows a relationship between the moving velocity of the nibbler and the frequency of the punch of the nibbler.

### DESCRIPTION OF EMBODIMENTS

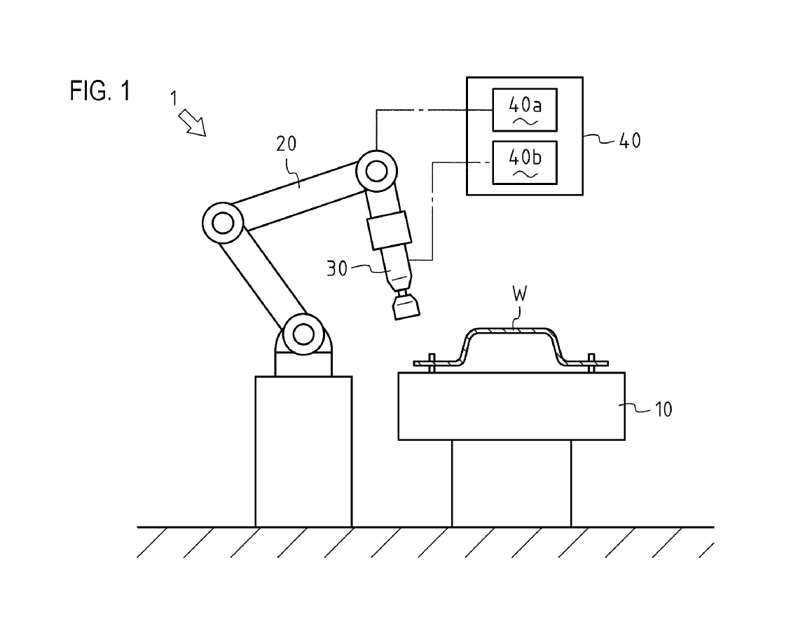

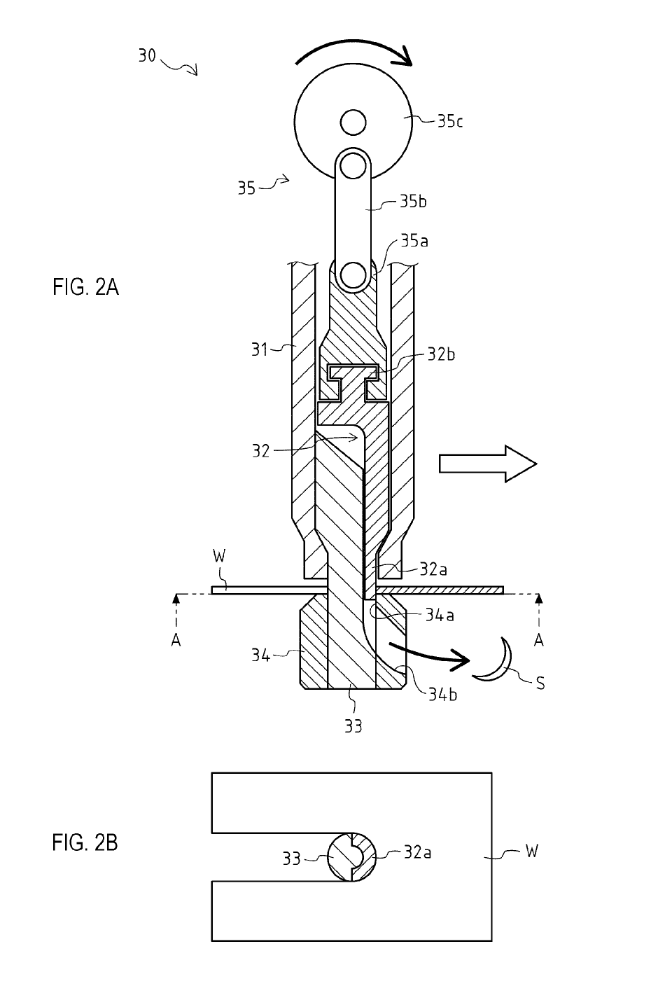

With reference to FIGS. 1 and 2, a cutting apparatus 1 as an embodiment of a cutting apparatus according to the present invention is described below.

The cutting apparatus 1 cuts a workpiece W which is a steel sheet.

As shown in FIG. 1, the cutting apparatus 1 includes a lower die 10, a robot 20, a nibbler 30, and a control device 40.

The lower die 10 is a member on which the workpiece W is placed. The lower die 10 is configured to fix the workpiece W.

The robot 20 has an arm with multiple joints. The robot 20 is configured to change a position and a posture of the arm. The nibbler 30 is attached to the tip of the arm of the robot 20.

As shown in FIGS. 2A and 2B, the nibbler 30 is a device which continuously punches the workpiece W while moving. The nibbler 30 includes a case 31, a punch 32, a supporting part 33, a die 34, and a driving part 35.

For convenience, a top-bottom direction in FIG. 2A is defined as a top-bottom direction of the nibbler 30.

The case 31 is formed in substantially a cylinder extending in the top-bottom direction, and the lower end part thereof is open.

The punch 32 is housed in the case 31 so as to slide in the top-bottom direction.

The supporting part 33 is fixed to the inner circumferential surface of the case 31, and supports the case 31 and the die 34.

The punch 32 reciprocates in the top-bottom direction at a predetermined frequency, and punches the workpiece W. The punch 32 has a blade 32a, and a connecting part 32b.

The blade 32a has a sectional shape of substantially a horseshoe, and the lower end thereof is formed as a blade edge for punching the workpiece W. The blade 32a protrudes downward from the lower end of the case 31 to enter an after-mentioned die hole 34a of the die 34 when the punch 32 arrives at the bottom dead center.

The connecting part 32b is connected to the driving part 35 so that the driving part 35 reciprocates the punch 32 in the top-bottom direction.

The supporting part 33 is a member which supports the case 31 and the die 34. The upper end part of the supporting part 33 is fixed to the inner circumferential surface of the case 31, and the supporting part 33 extends downward from the inside of the case 31. The supporting part 33 has such a shape that an opening coincident with the sectional shape of the blade 32a is formed on the lower end surface of the case 31. In other words, a space in which the punch 32 is housed is formed between the case 31 and a part of the supporting part 33 inserted into the case 31, and the opening of the space formed on the lower end surface of the case 31 has the shape coincident with the sectional shape of the blade 32a.

The die 34 is fixed to the lower end part of the supporting part 33.

The die 34 is arranged below the case 31 so as to be on the opposite side of the case 31 across the workpiece W. The die 34 is formed in substantially a cylinder. The die 34 is fixed to the supporting part 33 so as to cover the lower end part of the supporting part 33. The die 34 has the die hole 34a, and an ejecting hole 34b.

The die hole 34a is formed so that the blade 32a enter thereinto when the punch 32 arrives at the bottom dead center. Specifically, the die hole 34a is formed between the die 34 and a part of the supporting part 33 inserted into the die 34. The die hole 34a has the shape coincident with the sectional shape of the blade 32a, and opens on the upper end surface of the die 34.

The ejecting hole 34b is a hole through which a crescentic scrap S punched from the workpiece W by the punch 32 is ejected to the outside of the die 34. The ejecting hole 34b is formed on the lateral surface of the die 34, and communicates with the die hole 34a.

The driving part 35 reciprocates the punch 32 in the top-bottom direction at a predetermined frequency. The driving part 35 has a connecting part 35a, a rod 35b, and a motor 35c.

The connecting part 35a is connected to the connecting part 32b of the punch 32.

The rod 35b is connected to the motor 35c and the connecting part 35a so as to transmit power of the motor 35c to the connecting part 35a.

The motor 35c transmits power to the connecting part 35a through the rod 35b. Revolution of the motor 35c is converted into vertical movement of the connecting part 35a through the rod 35b.

As mentioned above, the nibbler 30 makes the punch 32 reciprocate in the top-bottom direction (direction in which the punch 32 moves into and out of proximity with the die 34) while moving in a predetermined direction with the workpiece W interposed between the case 31 and the die 34, thereby continuously punching the workpiece W.

As shown in FIG. 1, the control device 40 has a robot controlling part 40a, and a punch controlling part 40b.

The robot controlling part 40a is electrically connected to the robot 20, and is capable of controlling the robot 20. The robot controlling part 40a controls the robot 20 so that the nibbler 30 attached to the tip of the arm of the robot 20 moves along a predetermined path. In addition, the robot controlling part 40a controls the robot 20 so that the nibbler 30 attached to the tip of the arm of the robot 20 moves at a predetermined velocity.

Specifically, a storage (not shown) of the control device 40 contains a moving path of the nibbler 30 (technically, a path along which the tip of the arm of the robot 20 moves) and a moving velocity of the nibbler 30 (technically, a velocity at which the tip of the arm of the robot 20 moves), and the robot controlling part 40a controls the robot 20 based on such information.

The moving velocity of the nibbler 30 is set depending on the radius of curvature in the moving path of the nibbler 30 so that a velocity at which the nibbler 30 moves curvedly is smaller than a velocity at which the nibbler 30 moves linearly. In other words, a plurality of moving velocities of the nibbler 30 are set depending on the shape of the moving path of the nibbler 30.

The punch controlling part 40b is electrically connected to the nibbler 30, and is capable of controlling the nibbler 30. Specifically, the punch controlling part 40b is electrically connected to the motor 35c of the driving part 35 in the nibbler 30, and is capable of controlling a frequency of the punch 32 (the number of times per second that the punch 32 moves from the top dead center to the bottom dead center and then returns to the top dead center). The punch controlling part 40b controls the frequency of the punch 32 depending on the moving velocity of the nibbler 30.

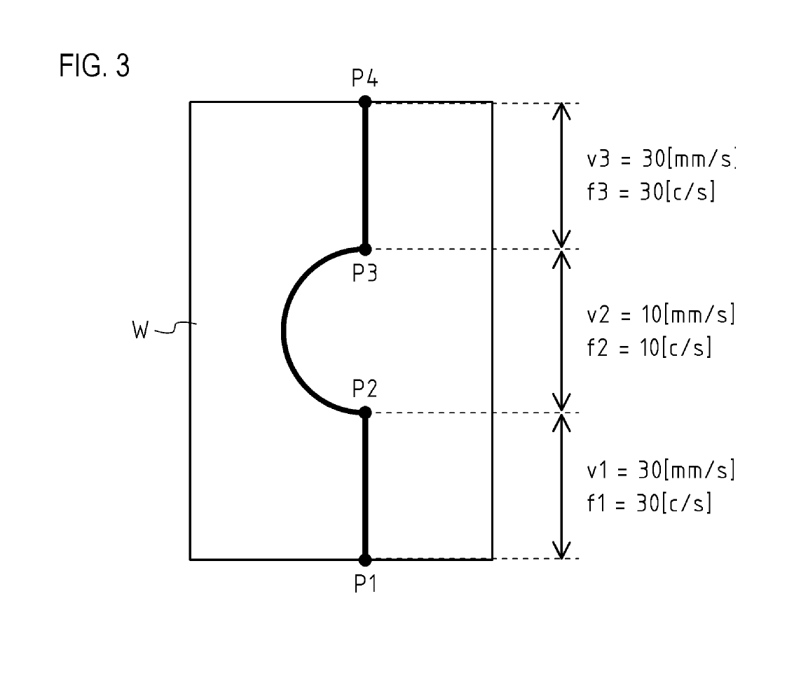

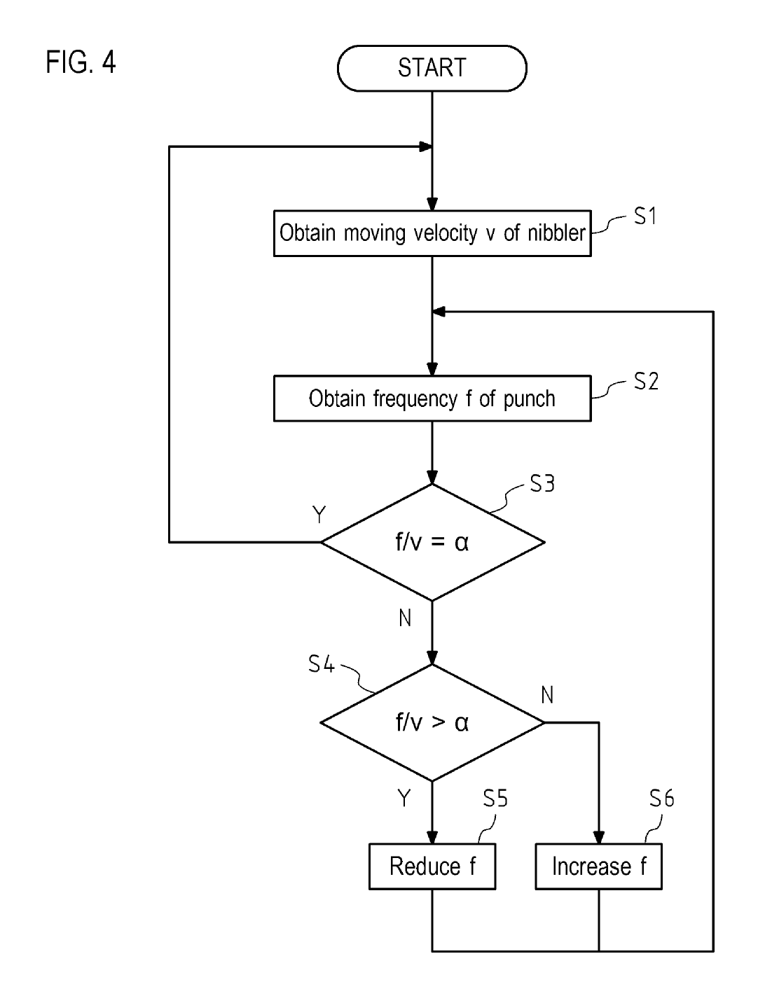

With reference to FIGS. 3 to 6, details of how the control device 40 operates are described below.

FIG. 3 shows the moving velocity of the nibbler 30 and the frequency of the punch 32 when the nibbler 30 cuts the workpiece W via positions P1 to P4 of the workpiece W in order.

In FIG. 3, the thick line on the workpiece W represents the moving path of the nibbler 30. The moving path of the nibbler 30 has the shape of a straight line from the position P1 to the position P2, an arc-shaped curve from the position P2 to the position P3, and a straight line from the position P3 to the position P4.

In the path from the position P1 to the position P2, the moving velocity of the nibbler 30 and the frequency of the punch 32 are v1 and f1, respectively. In the path from the position P2 to the position P3, the moving velocity of the nibbler 30 and the frequency of the punch 32 are v2 and f2, respectively. In the path from the position P3 to the position P4, the moving velocity of the nibbler 30 and the frequency of the punch 32 are v3 and f3, respectively.

As shown in FIG. 3, the robot controlling part 40a of the control device 40 controls the robot 20 so that the nibbler 30 moves at 30 [mm/s] from the position P1 to the position P2, at 10 [mm/s] from the position P2 to the position P3, and at 30 [mm/s] from the position P3 to the position P4 (v1=30 [mm/s], v2=10 [mm/s], v3=30 [mm/s]).

The punch controlling part 40b changes the frequency of the punch 32 so that a ratio between the moving velocity of the nibbler 30 and the frequency of the punch 32 is kept constant. Specifically, the punch controlling part 40b calculates f1, f2 and f3 so that the following expression is satisfied: v1:f1=v2:f2=v3:f3.

In the present embodiment, the punch controlling part 40b calculates f1, f2 and f3 so that a ratio of the frequency (unit: c/s) of the punch 32 to the moving velocity (unit: mm/s) of the nibbler 30 is 1. In other words, the punch controlling part 40b calculates f1, f2 and f3 so that the following equation is satisfied: (f1/v1)=(f2/v2)=(f3/v3)=1. As mentioned previously, values of v1, v2 and v3 are as follows: v1=30 [mm/s], v2=10 [mm/s], v3=30 [mm/s]. Therefore, values of f1, f2 and f3 are as follows: f1=30 [c/s], f2=10 [c/s], f3=30 [c/s].

Thus, the punch controlling part 40b of the control device 40 operates the punch 32 at 30 [c/s] during a movement of the nibbler 30 at 30 [mm/s] from the position P1 to the position P2, operates the punch 32 at 10 [c/s] during a movement of the nibbler 30 at 10 [mm/s] from the position P2 to the position P3, and operates the punch 32 at 30 [c/s] during a movement of the nibbler 30 at 30 [mm/s] from the position P3 to the position P4.

This makes it possible to punch the workpiece W so that an area of the scrap S, as seen in a plan view, is constant.

The punch controlling part 40b of the control device 40 controls the frequency of the punch 32 as follows, for example.

Specifically, the punch controlling part 40b performs steps S1 to S6.

In the step S1, the punch controlling part 40b obtains a current moving velocity v of the nibbler 30 from the robot controlling part 40a.

In the step S2, the punch controlling part 40b obtains a current frequency f of the punch 32 from the motor 35c of the nibbler 30.

In the step S3, the punch controlling part 40b determines whether a ratio of the frequency f to the moving velocity v is α or not. α is a predetermined constant, and a value of a is as follows in the present embodiment: α=1.

If the ratio of the frequency f to the moving velocity v is α ((f/v) =α), the punch controlling part 40b maintains the frequency f and performs the step S1 again.

If the ratio of the frequency f to the moving velocity v is not α ((f/v) ≠α), the punch controlling part 40b performs the step S4.

In the step S4, the punch controlling part 40b determines whether the ratio of the frequency f to the moving velocity v is larger than α or not.

If the ratio of the frequency f to the moving velocity v is larger than α ((f/v) >α), the punch controlling part 40b performs the step S5.

If the ratio of the frequency f to the moving velocity v is smaller than α ((f/v) <α), the punch controlling part 40b performs the step S6.

In the step S5, the punch controlling part 40b controls the motor 35c of the nibbler 30 to reduce the frequency f.

The punch controlling part 40b performs the step S2 again after performing the step S5.

In the step S6, the punch controlling part 40b controls the motor 35c of the nibbler 30 to increase the frequency f.

The punch controlling part 40b performs the step S2 again after performing the step S6.

As mentioned above, the punch controlling part 40b controls the frequency of the punch 32 so that the ratio between the moving velocity of the nibbler 30 and the frequency of the punch 32 is kept constant.

Conventionally, a nibbler is operated at a constant frequency of a punch.

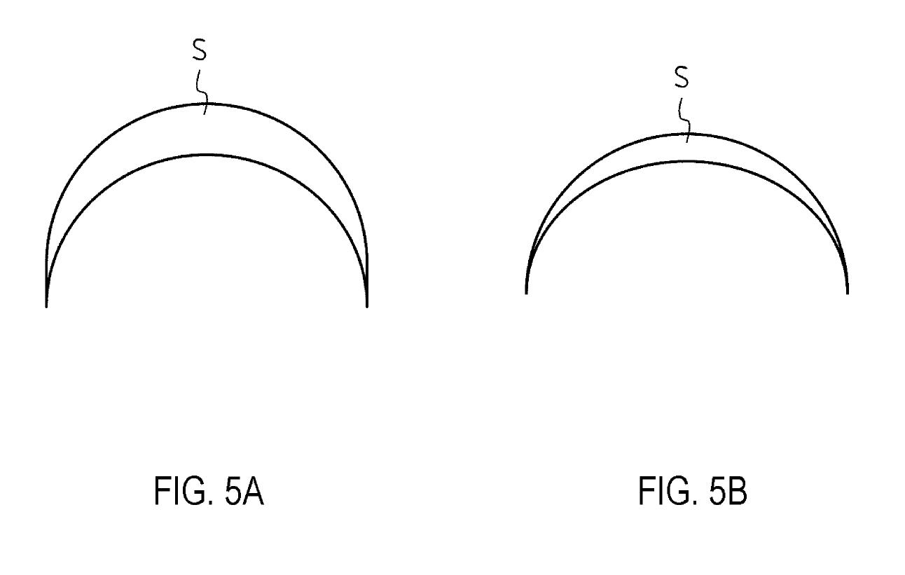

Therefore, as shown in FIGS. 5A and 5B, an area of the scrap S, as seen in a plan view, varies depending on the moving velocity of the nibbler. In other words, as the moving velocity of the nibbler decreases, the area of the scrap S, as seen in a plan view, decreases. FIG. 5A is a plan view of the scrap S when moving a conventional nibbler along a linear path such as the path from the position P1 to the position P2 or the path from the position P3 to the position P4. FIG. 5B is a plan view of the scrap S when moving the conventional nibbler along a curved path such as the path from the position P2 to the position P3.

In contrast, in the cutting apparatus 1 according to the present invention, the frequency of the punch 32 varies so that the ratio between the moving velocity of the nibbler 30 and the frequency of the punch 32 is constant.

As a result, the area of the scrap S, as seen in a plan view, is kept constant.

It is desirable that the frequency of the punch 32 is set so that the area of the scrap S, as seen in a plan view, is large as much as possible. For example, the frequency of the punch 32 is set so that the area of the scrap S, as seen in a plan view, is large as much as possible (so that the scrap S shown in FIG. 5A is cut out) in a path where the moving velocity of the nibbler 30 is largest, and on the basis thereof, the frequency of the punch 32 in the other paths may be calculated.

This makes it possible to minimize a reduction in the area of the scrap S as seen in a plan view even when the nibbler 30 moves curvedly at a small velocity.

Therefore, it is possible to minimize an increase in the number of times of punching during a cut of the workpiece W, and to minimize abrasion of the punch 32.

As a result, it is possible to extend a life of the punch 32 provided in the nibbler 30.

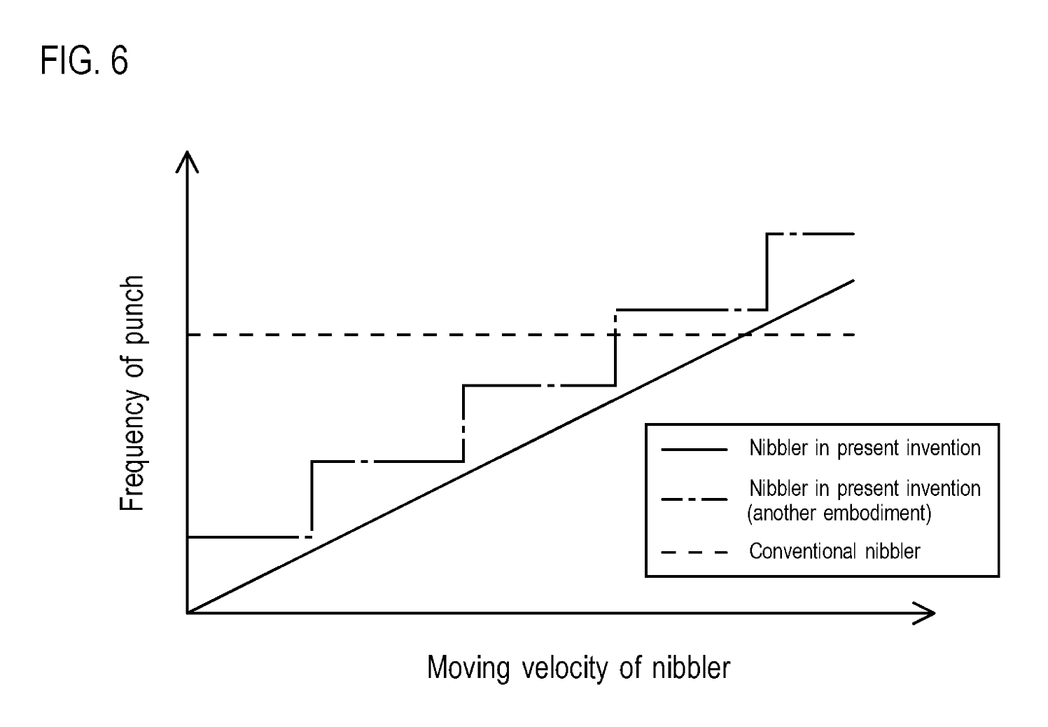

As shown in FIG. 6, in the present embodiment, the frequency of the punch 32 is changed so that the ratio between the moving velocity of the nibbler 30 and the frequency of the punch 32 is kept constant (see a solid line in FIG. 6). However, the ratio between the moving velocity of the nibbler 30 and the frequency of the punch 32 need not be constant as long as the area of the scrap S, as seen in a plan view, is constant (see an alternate long and short dash line in FIG. 6). The graph indicated by the alternate long and short dash line in FIG. 6 shows that the frequency of the punch 32 varies stepwise depending on the moving velocity of the nibbler 30.

FIG. 6 shows a relationship between the moving velocity of the nibbler and the frequency of the punch, in which the horizontal axis represents the moving velocity of the nibbler, and the vertical axis represents the frequency of the punch. The graph indicated by a broken line in FIG. 6 shows a relationship between the moving velocity of the conventional nibbler and the frequency of the punch of the conventional nibbler.

In the present embodiment, the ratio of the frequency (unit: c/s) of the punch 32 to the moving velocity (unit: mm/s) of the nibbler 30 is 1, but the ratio may be changed as needed.

The number of robots 20 is not limited. It is required that at least one robot 20 to which the nibbler 30 is attached is provided.

If two or more robots 20 are provided, it is required that the nibbler 30 is attached to at least one robot 20.

### INDUSTRIAL APPLICABILITY

The present invention is applicable to a cutting apparatus and cutting method for cutting a steel sheet.

### REFERENCE SIGNS LIST

1: cutting apparatus
10: lower die
20: robot
30: nibbler
31: case
32: punch
33: supporting part
34: die
35: driving part
40: control device
40a: robot controlling part
40b: punch controlling part
W: workpiece (steel sheet)
S: scrap

What is claimed is:

1. A cutting apparatus for cutting a steel sheet, comprising:
at least one robot which has an arm capable of changing a position and a posture of the arm;
a nibbler attached to a tip of the arm of the robot, which has a punch reciprocating in a top-bottom direction to punch the steel sheet; and
a control device which controls the robot and the nibbler,
wherein the nibbler makes the punch continuously punch the steel sheet while being moved by the robot, thereby cutting the steel sheet, and
wherein the control device has a robot controlling part which controls the robot so that the nibbler moves at a moving velocity depending on a shape of a moving path of the nibbler, and a punch controlling part which changes a frequency of the punch according to the moving velocity of the nibbler.

2. The cutting apparatus according to claim 1, wherein
the punch controlling part of the control device obtains the moving velocity of the nibbler and the frequency of the punch,
if the punch controlling part determines that a ratio of the frequency of the punch to the moving velocity of the nibbler is larger than a predetermined value, the punch controlling part reduces the frequency of the punch so that the ratio of the frequency of the punch to the moving velocity of the nibbler is the predetermined value, and
if the punch controlling part determines that the ratio of the frequency of the punch to the moving velocity of the nibbler is smaller than the predetermined value, the punch controlling part increases the frequency of the punch so that the ratio of the frequency of the punch to the moving velocity of the nibbler is the predetermined value.

3. A cutting method for cutting a steel sheet, comprising:
attaching a nibbler to at least one robot, the nibbler having a punch which reciprocates in a top-bottom direction to punch the steel sheet;
controlling the robot so that the nibbler moves at a moving velocity depending on a shape of a moving path of the nibbler; and
changing a frequency of the punch according to the moving velocity of the nibbler.

4. The cutting method according to claim 3, wherein
if a ratio of the frequency of the punch to the moving velocity of the nibbler is larger than a predetermined value, reducing the frequency of the punch so that the ratio of the frequency of the punch to the moving velocity of the nibbler is the predetermined value, and
if the ratio of the frequency of the punch to the moving velocity of the nibbler is smaller than the predetermined value, increasing the frequency of the punch so that the ratio of the frequency of the punch to the moving velocity of the nibbler is the predetermined value.
